(19) United States
(12) Patent Application Publication
(10) Pub. No.: US 2022/0065125 A1
(43) Pub. Date: Mar. 3, 2022

(54) ENERGY RECOVERY FOR HIGH POWER PUMPING SYSTEMS AND METHODS USING EXHAUST GAS HEAT TO GENERATE THERMOELECTRIC POWER

(71) Applicant: BJ Energy Solutions, LLC, Houston, TX (US)

(72) Inventors: Mike Spencer, Houston, TX (US); Charles Keith Alberston, Houston, TX (US); Tony Yeung, Houston, TX (US)

(73) Assignee: BJ Energy Solutions, LLC, Houston, TX (US)

(21) Appl. No.: 17/304,322

(22) Filed: Jun. 18, 2021

Related U.S. Application Data
(60) Provisional application No. 62/705,358, filed on Jun. 23, 2020.

(51) Int. Cl. F01D 15/10; F01D 15/08; E21B 43/26; F01D 19/00; F01D 25/28; F04B 17/03; F04B 17/05; F04B 17/06; F01D 25/30

(52) U.S. Cl. CPC F01D 15/10; F01D 15/08; E21B 43/2607; F01D 19/00; F01D 25/28; F05D 2220/76; F04B 17/05; F04B 17/06; F01D 25/30; F05D 2220/62; F04B 17/03

(57) ABSTRACT

Embodiments of a power generation system and methods to be used in conjunction with a high-powered turbine engine are disclosed. The power generation system includes a turbine engine having an exhaust diffuser section installed on the exhaust duct of the turbine engine and a turbine engine exhaust stack assembly connected to the turbine engine exhaust diffuser section. An embodiment further includes thermo-electric generator (TEGs) sub-assemblies connected to the turbine engine exhaust stack assembly. In other embodiments electrical storage devices such as batteries are used.

This U.S. Non-Provisional patent application claims priority to and the benefit of, under 35 U.S.C. § 119(e), U.S. Provisional Application No. 62/705,358, filed Jun. 23, 2020, entitled “Energy Recovery for High Power Pumping Systems and Methods Using Exhaust Gas Heat to Generate Thermoelectric Power,” the disclosure of which is incorporated herein by reference in its entirety.

### TECHNICAL FIELD

The present disclosure relates generally to environments and applications that use turbo-shaft turbine engines as the prime mover to rotate a load. The present disclosure will primarily relate to the high pressure pumping industry, particularly to pump systems and methods for hydraulic fracturing.

### BACKGROUND

Fracturing is an oilfield operation that stimulates production of hydrocarbons, such that the hydrocarbons may more easily or readily flow from a subsurface formation to a well. For example, a fracturing system may be configured to fracture a formation by pumping a fracturing fluid into a well at high pressure and high flow rates. Some fracturing fluids may take the form of a slurry including water, proppants, and/or other additives, such as thickening agents and/or gels. The slurry may be forced via one or more pumps into the formation at rates faster than can be accepted by the existing pores, fractures, faults, or other spaces within the formation. As a result, pressure builds rapidly to the point where the formation may fail and may begin to fracture. By continuing to pump the fracturing fluid into the formation, existing fractures in the formation are caused to expand and extend in directions farther away from a well bore, thereby creating flow paths to the well bore. The proppants may serve to prevent the expanded fractures from closing when pumping of the fracturing fluid is ceased or may reduce the extent to which the expanded fractures contract when pumping of the fracturing fluid is ceased. Once the formation is fractured, large quantities of the injected fracturing fluid are allowed to flow out of the well, and the production stream of hydrocarbons may be obtained from the formation.

Prime movers may be used to supply power to a plurality of fracturing pumps for pumping the fracturing fluid into the formation. Traditionally, these high pressure, high volume pumping applications use diesel reciprocating engines to drive each of the plurality of reciprocating piston pumps in a system to deliver fluid to subsurface geological formations and fracture these formations to release the hydrocarbons for production. Also, a plurality of gas turbine engines may each be mechanically connected to a corresponding fracturing pump and may be operated to drive the corresponding fracturing pump. A fracturing unit may include a gas turbine engine or other type of prime mover and a corresponding fracturing pump, as well as auxiliary components for operating and controlling the fracturing unit, including electrical, pneumatic, and/or hydraulic components. The gas turbine engine, fracturing pump, and auxiliary components may be connected to a common platform or trailer for transportation and set-up as a fracturing unit at the site of a fracturing operation, which may include up to a dozen or more of such fracturing units operating together to perform the fracturing operation. In order to supply electrical, pneumatic, and/or hydraulic power for operation of the auxiliary components, an additional prime mover may be used.

### SUMMARY

In the field of hydraulic fracturing or fracking, the use of conventional diesel engines may be replaced with turbine engines to either directly drive a pump from the turbine output shaft or use the turbine to generate electrical power and distribute that power to electrical motors directly connected to pumps (e.g., electrical fracking) for the present disclosure. The replacement of reciprocating diesel engines with turbine engines, for example, may allow reduction in space and weight conventionally required by a prime mover as well as an increase in power density, thereby allowing greater values of shaft horse power (SHP) and torque to be generated and resulting in a reduction of fracturing trailers required to generate hydraulic horse power (HHP) demand.

A turbine engine also may have a reduction gearbox connected to it, or used in association with it, to allow for high speed rotation of a turbine output shaft to be reduced to a useable speed while still utilizing maximum power and torque. In fracturing applications, for example, the ratio of reduction for the high speed gearbox may be as high as a 11:1 reduction ratio as understood by those skilled in the art.

In the disclosure, Applicant has recognized that the replacement of reciprocating diesel engines with turbine engines may not eradicate requirements or needs for auxiliary systems onboard a fracturing trailer. The turbine engine still requires power to be delivered to fuel systems and lubrication systems as well as electrical and instrumentation devices. In addition to the turbine power requirements, other installed machinery onboard a fracturing trailer requires external power to drive lubrication systems, cooling systems, pumps and associated electrical devices. Some machinery and components may include the reciprocating fracturing pumps and the reduction gearbox. Currently these auxiliary support systems are powered using hydraulics or electrical power generation that includes a reciprocating diesel engine being directly connected to a hydraulic pump or an assembly of hydraulic pumps or an electrical generator. The assembly of these systems may be expensive, complicated, space consuming and heavy, which all contribute to building and compliance difficulties of hydraulic fracturing trailers according to government and industry standards.

Accordingly, in the disclosure, Applicant has recognized that there is a need for an efficient, compact power generation system to be used onboard a turbine driven hydraulic fracturing pumping trailer that may use turbine waste energy to assist in powering trailer auxiliary functions and allowing for recovered energy to be stored and used when needed.

In an embodiment, for example, a hydraulic fracturing power generation system, positioned onboard a hydraulic fracturing trailer assembly, includes a high-power hydraulic fracturing generation assembly having a turbine engine mounted to the hydraulic fracturing trailer assembly, a reduction gear box connected to the turbine engine and mounted to the hydraulic fracturing trailer assembly, a drive shaft connected to the reduction gear box and mounted to the hydraulic fracturing trailer assembly, and a turbine engine exhaust diffuser section mounted to the hydraulic fracturing trailer assembly and connected to the turbine engine, a reciprocating plunger pump connected to the drive shaft and mounted to the hydraulic fracturing trailer assembly, and a thermoelectric power generation assembly mounted to the hydraulic fracturing trailer assembly. The thermoelectric power generation assembly includes a turbine engine exhaust stack assembly mounted to the hydraulic fracturing trailer assembly and connected to the turbine engine exhaust diffuser section, a set of thermo-electric generator (TEG) sub-assemblies connected to the turbine exhaust stack sub-assembly to generate electric power responsive heat from the exhaust stack sub-assembly, and a power storage and distribution source mounted to the hydraulic fracturing trailer assembly to store and distribute power generated from the set of TEG sub-assemblies across the hydraulic fracturing trailer assembly. The power storage and distribution source, for example, may include a set of batteries, and the system also may have a diesel engine alternator mounted to the hydraulic fracturing trailer assembly and connected to the set of TEG sub-assemblies to enhance production and distribution of electrical power across the hydraulic fracturing trailer assembly. The system additionally may have a turbine engine starter motor mounted to the hydraulic fracturing trailer assembly so that the set of TEG assemblies operatively charges the power source, e.g., the set of batteries, thereby to enhance supply of power to the turbine engine starter motor for starting the turbine engine. In embodiments, the turbine engine, for example, may be a dual shaft turbine engine with an exhaust stack assembly equipped with TEGs that are then connected to an energy storage device, and from that storage device the energy is distributed around the fracturing trailer as a source of power.

An embodiment of a method to generate thermoelectric power for a hydraulic fracturing trailer assembly having a high-power hydraulic fracturing generation assembly positioned thereon, for example, may include operating a high-power turbine engine of the power generation assembly when adjacent a fracturing well site so as to produce exhaust gas therefrom, supplying the exhaust gas from the high-power turbine engine into a turbine engine exhaust stack assembly, and generating thermoelectric power from a set of thermoelectric generation (TEG) assemblies responsive to heat from the exhaust gas in the turbine engine exhaust stack assembly so as to supply power to a power storage and distribution source associated with the hydraulic fracturing trailer assembly. The method also may include operating a diesel engine alternator when connected to the set of TEG assemblies to enhance production and distribution of electrical power across the high-power hydraulic fracturing generation assembly. In embodiments of the disclosure, the turbine engine exhaust stack assembly may include an exhaust stack housing and a TEG housing mount assembly, and the set of TEG assemblies may be mounted to the exhaust stack housing via the TEG housing mount assembly so that the TEG assemblies receive heat from the turbine engine exhaust stack assembly when mounted to the exhaust stack housing. The method further may include controlling power levels associated with components of the high-power hydraulic fracturing generation assembly via a controller and the set of TEG assemblies.

In another embodiment, an assembly of thermo-electric generators (TEGs) may be installed on the exhaust stack assembly of a dual shaft turbine engine, for example, but in addition to the TEGs in place, the energy recovery system is used in conjunction with a solar energy recovery assembly that includes TEGs, energy storage devices, solar panels, and electrical circuit protection that is then distributed around a fracturing trailer. In still another embodiment, a method for storing the generated power on a separate trailer is disclosed. The energy storage trailer would include battery bank systems, circuit protection components, electrical switch gear as well as related electrical controlling components to monitor system variables.

### BRIEF DESCRIPTION OF THE DRAWINGS

The present disclosure may be more readily described with reference to the accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. According to common practice, the various features of the drawings discussed below are not necessarily drawn to scale. Dimensions of various features and elements in the drawings can be expanded or reduced to more clearly illustrate embodiments of the invention.

FIG. 1 is a schematic view of a power diagram of a dual shaft turbine engine of a hydraulic fracturing power generation system according to an embodiment of the disclosure.

FIG. 2 is perspective view of a general arrangement of a dual shaft turbine engine having an exhaust diffuser, with portions broken away for clarity, of a hydraulic fracturing power generation system according to an embodiment of the disclosure.

FIG. 3A is perspective view of a thermal electric generator (TEG) sub-assembly of a hydraulic fracturing power generation system according to an embodiment of the disclosure.

FIG. 3B is an exploded perspective view of a thermal electric generator (TEG) sub-assembly as shown in FIG. 3A of a hydraulic fracturing power generation system according to an embodiment of the disclosure.

FIG. 4 a side elevational view of a shows a turbine engine exhaust stack, with portions broken away for clarity, of a hydraulic fracturing power generation system to be installed on a hydraulic fracturing trailer according to an embodiment of the disclosure.

FIG. 5 shows a turbine exhaust stack installed with a set of TEG sub-assemblies, with portions broken away for clarity, of a hydraulic fracturing power generation system according to an embodiment of the disclosure.

FIG. 6 is a graph of temperature profile (degrees Fahrenheit) versus radius (feet) that shows an exhaust gas velocity (feet/second) and temperature profile plotted against each other according to an embodiment of the disclosure.

FIG. 7 is a graph of exhaust gas temperature (EGT) (degrees Fahrenheit) and hydraulic horsepower (HHP) that demonstrates the correlation between the two variables according to an embodiment of the disclosure.

FIG. 8 is a schematic view of an electrical circuit and process diagram of a thermal electric generator (TEG) circuit during working conditions according to an embodiment of the disclosure.

FIG. 9 is a sectional view of a thermal electric generator mounted to a thermal conducting surface of a turbine engine stack assembly housing according to an embodiment of the disclosure.

### DETAILED DESCRIPTION

The disclosure is described in various embodiments in the following description with the reference to the figures, in which like numbers and text represent the same or similar elements. Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment. The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

The described features, structures, or characteristics of the disclosure may be combined in any suitable manner in one or more embodiments as will be understood by those skilled in the art. In the following description, numerous specific details are recited to provide a thorough understanding of embodiments of the disclosure. One skilled in the relevant art will recognize, however, that the disclosure may be practiced without one or more of the specific details, or with other methods, components, materials and so forth. In other instances, well known structures, materials, or operations are not shown or described in details to avoid obscuring aspects of the disclosure.

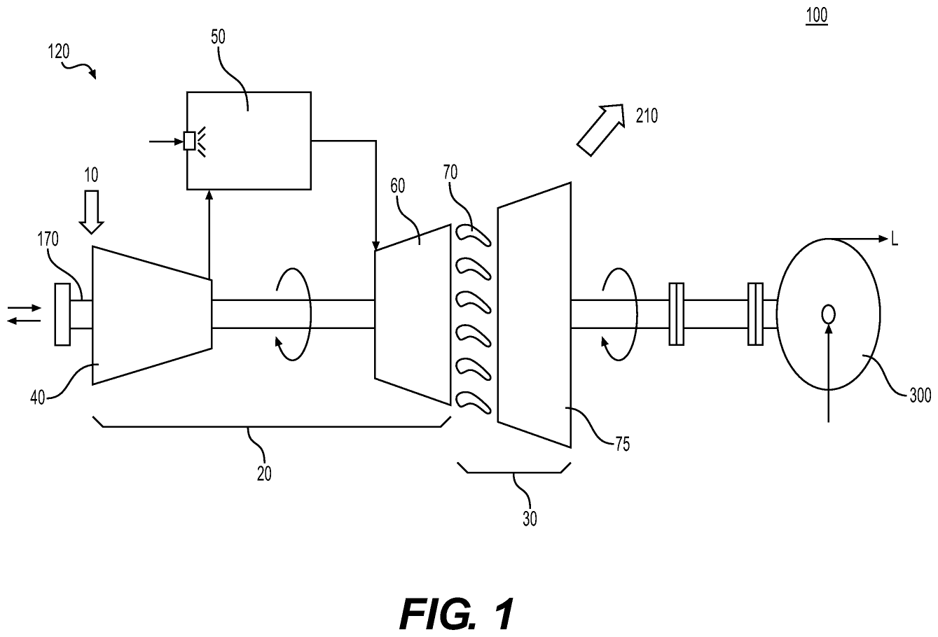

The disclosure includes a turbine engine pump assembly 100 (see FIG. 1) used in high pressure high volume pumping operations in the oil and gas well stimulation sector; this process is commonly referred to as hydraulic fracturing. Such hydraulic fracturing applications, for example, may require pressures greater than 12,000 pounds per square inch (PSI) and volumes greater than 100 barrels per minute (BPM) as will be understood by those skilled in the art. The high pressure and flow requirement results in the fracturing industry needing to use high powered turbine engines to directly drive reciprocating fracturing pumps allowing for an increased power to weight ratio for the prime mover resulting in a reduction of fracturing trailers that are able to supply equal amounts of hydraulic horsepower (HHP) compared to conventional reciprocating diesel frac or fracturing fleets.

As illustrated in FIG. 1, an exemplary embodiment of a dual shaft turbine engine power diagram demonstrates the combustion cycle and the resulting power output. A dual shaft turbine engine 120 is intended to be used with this disclosure, but, as will be understood by those skilled in the art, single shaft turbine engine systems are included in the disclosed embodiments and encapsulated in the disclosure premises. The exhaust gas 210 that is expelled from the turbine engine power cycle is of high velocity and high temperature. The energy that is not generated to perform kinetic energy is mostly lost through the heat as will be understood by those skilled in the art. This exhaust gas heat is intended to be used to recover energy lost in the turbines Brayton cycle and convert to usable electrical energy according to the disclosure. As previously mentioned, the load L intended to turn with the dual shaft turbine engine 120 is a reciprocating plunger pump 300 as will be understood by those skilled in the art; however, the load L in some embodiments may include an electrical generator or another pump type, all may be included and may be applicable to the disclosure. The dual shaft turbine engine 120 also includes an air inlet 10, gas generator 20 and power turbine 30. The gas generator 20 includes axial compressor 40, combustor 50 and gas generator stages 60. The power turbine 30 includes variable area vanes 70 and power turbine stages 75.

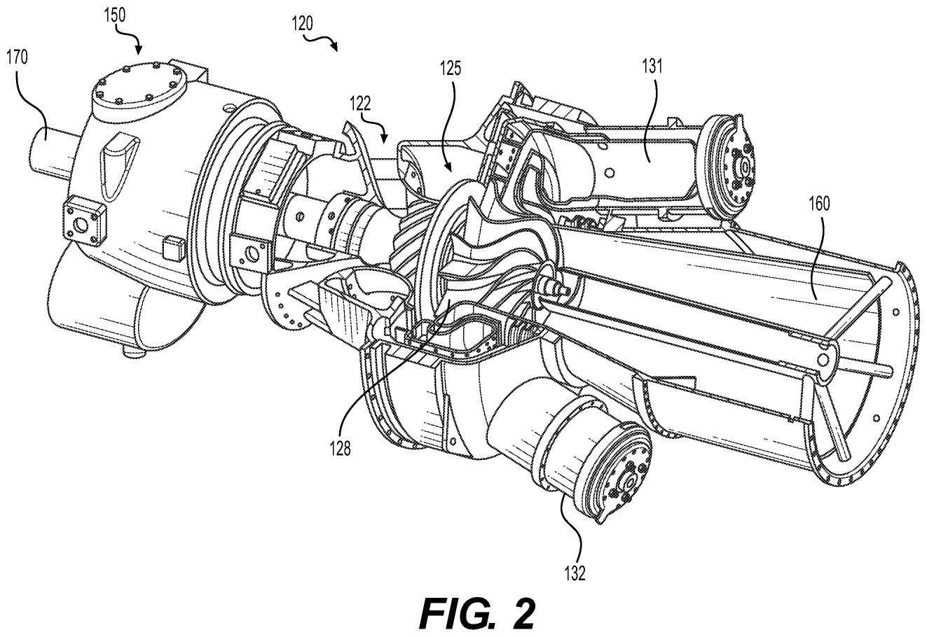

FIG. 2 is a three-dimensional (3D) representation or perspective view of a turbine engine 120 with the turbine internal components being shown in a cut away section. The 3D representation of the turbine engine shows; the air inlet ducts 122, turbine compressor section 125, power turbine 128, combustion chambers 131, 132, output shafting 170, a reduction gearbox 150, and a turbine engine exhaust diffuser section 160. The turbine engine exhaust diffuser section 160 reduces the velocity of the exhaust gases 210 and recovers exhaust pressure before the turbine exhaust gases 210 enter exhaust stack ducting 182.

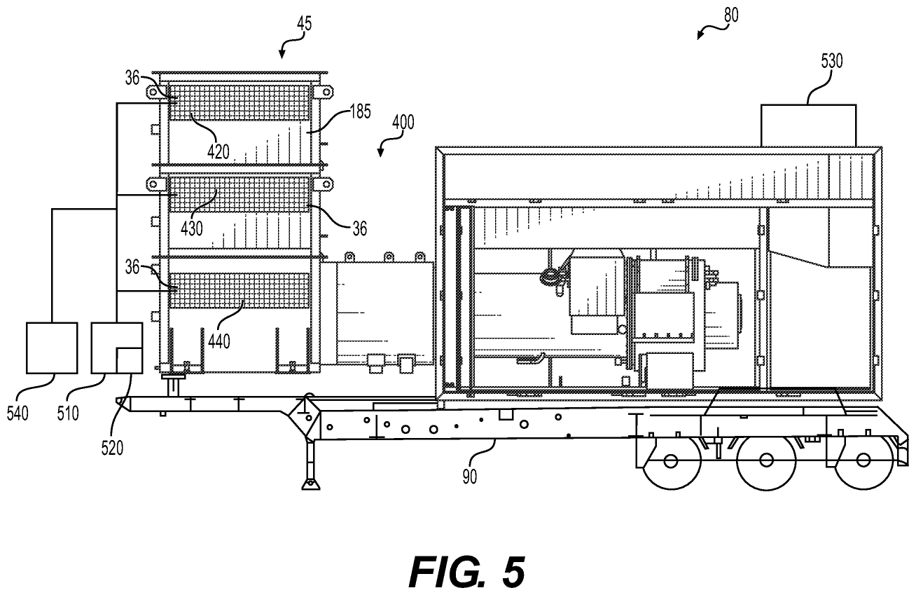

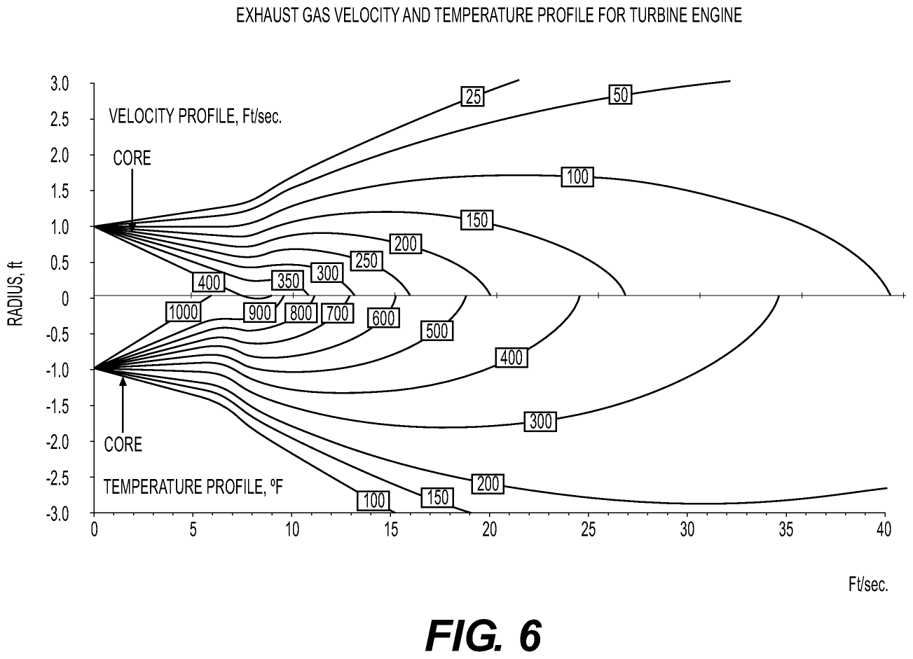

In an embodiment, a hydraulic fracturing power generation system 80, positioned onboard a hydraulic fracturing trailer assembly 90, includes a high-power hydraulic fracturing generation assembly 100 having a turbine engine 120 mounted to the hydraulic fracturing trailer assembly 90, a reduction gear box 150 connected to the turbine engine 120 and mounted to the hydraulic fracturing trailer assembly 90, a drive shaft 170 connected to the reduction gear box 150 and mounted to the hydraulic fracturing trailer assembly 90, and a turbine engine exhaust diffuser section 160 mounted to the hydraulic fracturing trailer assembly 90 and connected to the turbine engine 120, a reciprocating plunger pump 300 connected to the drive shaft 170 and mounted to the hydraulic fracturing trailer assembly 90, and a thermoelectric power generation assembly 400 mounted to the hydraulic fracturing trailer assembly 90. The thermoelectric power generation assembly 400 includes a turbine engine exhaust stack assembly 45 mounted to the hydraulic fracturing trailer assembly 90 and connected to the turbine engine exhaust diffuser section 160, a set of thermo-electric generator (TEG) sub-assemblies 420, 430, 440 connected to the turbine exhaust stack assembly 45 to generate electric power responsive heat from the exhaust stack assembly 45, and a power storage and distribution source 510 mounted to the hydraulic fracturing trailer assembly 90 to store and distribute power generated from the set of TEG sub-assemblies 420, 430, 440 across the hydraulic fracturing trailer assembly 90, as shown in FIG. 5. The TEG sub-assemblies 420, 430, 440 can cover all sides of the turbine exhaust stack assembly 45 and can be positioned at any location where exhaust heat can be used to generate electricity. The power storage and distribution source 510 could be located anywhere on the hydraulic fracturing trailer assembly 90 or at a remote location. The exhaust stack assembly 45 may include an exhaust stack housing 185 and a TEG housing mount assembly 188 as illustrated. The set of TEG sub-assemblies 420, 430, 440 may be mounted to the exhaust stack housing 185 by the TEG housing mount assembly 188 as illustrated and as will be understood by those skilled in the art.

The power storage and distribution source 510, for example, also may include a set of batteries 520, and the system 80 also may have a diesel engine alternator 260 mounted to the hydraulic fracturing trailer assembly 90 and connected to, or otherwise in electrical communication with, the set of TEG sub-assemblies 420, 430, 440 to enhance production and distribution of electrical power across the hydraulic fracturing trailer assembly 90. The system 80 additionally may have a turbine engine starter motor 270, as will be understood by those skilled in the art, mounted to the hydraulic fracturing trailer assembly 90 so that the set of TEG assemblies 420, 430, 440 operatively charges the power source 510, e.g., the set of batteries 520, thereby to enhance supply of power to the turbine engine starter motor 270 for starting the turbine engine 120. In embodiments, the turbine engine 120, for example, may be a dual shaft turbine engine with an exhaust stack assembly 45 equipped with the TEGs 420, 430, 440 that are then connected to an energy storage device 510, and from that storage device 510 the energy is distributed around the fracturing trailer 90 as a source of power.

Embodiments of a thermoelectric power generation system further may include an electrical controller 600 positioned in electrical communication with the set of TEG sub-assemblies 420, 430, 440 to control and monitor power levels of components associated with the hydraulic fracturing power generation system 80 via the TEG sub-assemblies. Also, the high-power hydraulic fracturing generation assembly 100 still further may include a turbine engine starter motor 270 mounted to the hydraulic fracturing trailer assembly 90, and the set of TEG sub-assemblies 420, 430, 440 may be positioned operatively to charge the set of batteries 520 to power the turbine engine starter motor 270 for starting the turbine engine 120.

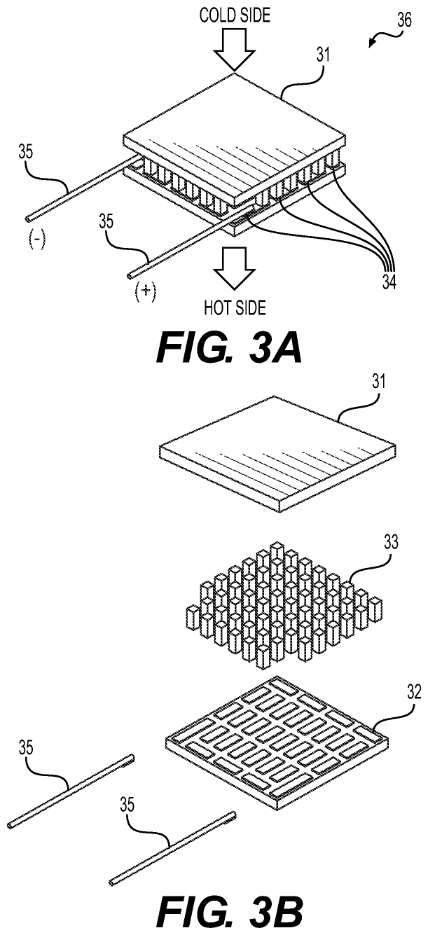

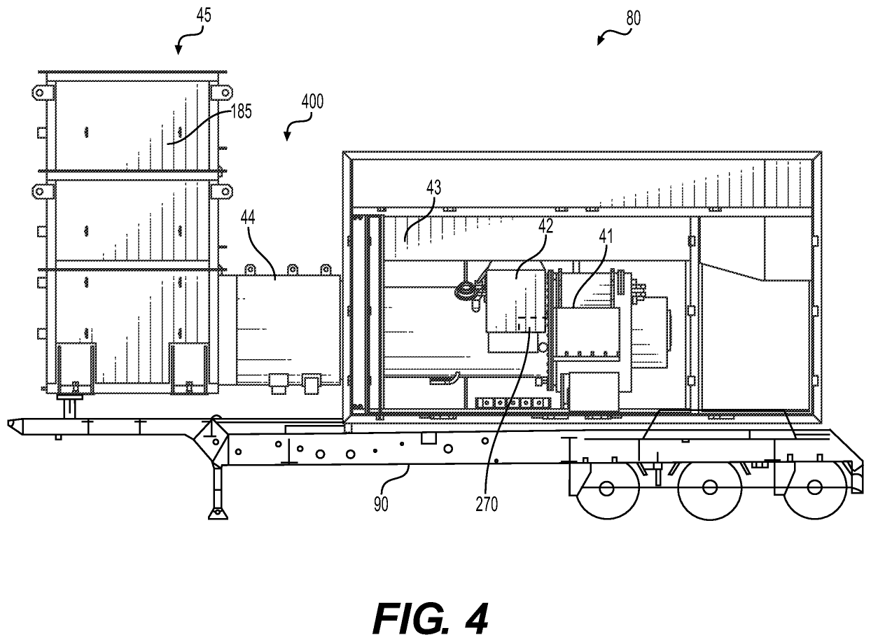

FIGS. 3A-3B shows a general arrangement of a thermo-electric generator sub-assembly 36 comprising of ceramic plates 31, electrical conductors 32, pellets 33, solder and terminal wires 35. An illustration of the proposed trailer mounted exhaust stack for the turbine engine is shown in FIG. 4. An illustration of the thermo-electric generators as installed on the exhaust stack is shown in FIG. 5. An embodiment of a method for mounting these TEG sub-assemblies is demonstrated in FIG. 9. In FIG. 9 the thermal conductive surface 91 is shown, and according to an embodiment of the disclosure, this will be the exhaust stack onboard a turbine driven hydraulic fracturing pumping trailer. However, the thermal conductive surface for mounting these TEGs may be the exhaust stack of a turbine genset or the exhaust manifold of a reciprocating diesel engine as will be understood by those skilled in the art. All are deemed as extensions of the embodiments shown in this disclosure. As shown in FIG. 9, holes can be drilled and tapped into the exhaust stack 91, to allow for the TEG 93 to be placed on its surface. The TEG can be secured using a heat sink 94 and two mounting screws 92. The turbine engine assembly 42 shown in FIG. 4 is directly connected to a reduction gearbox assembly 41 and the assembly is installed in an enclosure 43.

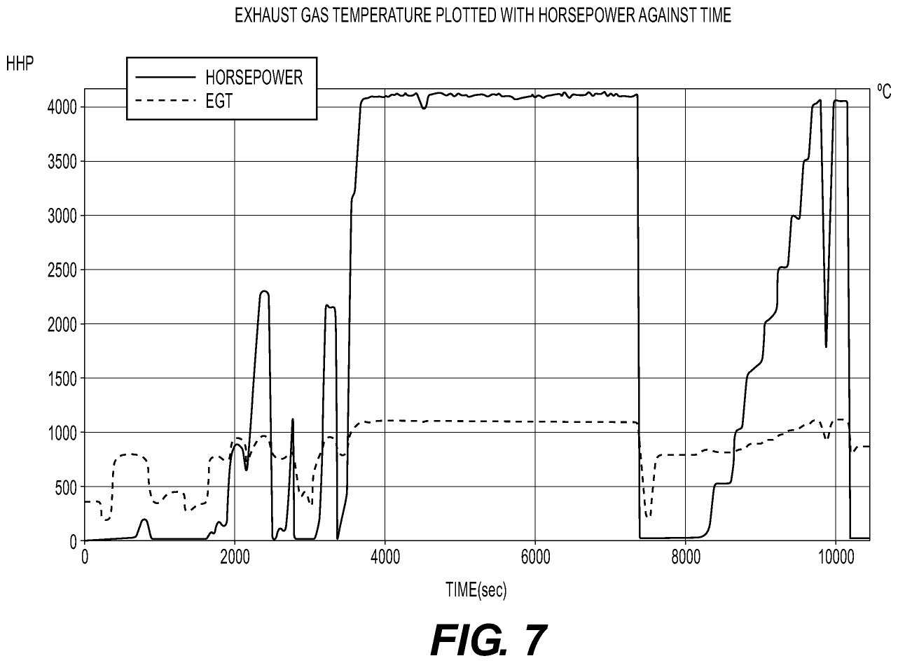

As shown in FIG. 4, when operating, embodiments of the turbine engine assembly 42 will exhaust waste gases from combustion through a diffuser 44 and into the exhaust stack assembly 45. Depending on the horsepower (HP) produced by the turbine engine, the exhaust gases mass flow and exhaust gas temperature (EGT) will increase with HP demand. This correlation between horsepower and EGT may be seen in FIG. 7, for example, with the solid line representing the HP and the dashed line representing the EGT. At the center of the data sample is a sharp increase in HP demand with a sustained power draw until eventually the power draw is reduced. A similar pattern is clearly visible at the same time interval with regards to the EGT. During different temperatures, energy may still be produced from the TEG sub-assemblies but each sub-assembly will have an optimal temperature in which it may convert the thermal energy into useable electrical energy.

Due to a large amount of TEGs being installed, FIG. 5 shows a proposed placement of the TEG sub-assemblies 36 onto the exhaust stack assembly 45. Each sub-assembly 36 is seen as an independent component and is part of the whole TEG assembly for that section of the exhaust stack. TEGs require testing to ensure that not only terminal wires are intact and successfully transferring the power into the circuit but also that the conductors are intact and operating at optimum efficiency. The separation of these assemblies running with their own individual electrical circuits allows the amount of TEGs to be monitored on a reduced scale and allows for the maintenance team to be able to take a smaller component sample when testing the circuits power generation and, if required, allows identifying damaged sub-assemblies. Each assembly of sub-assemblies will run in to a series of battery banks (not shown) that will store the generated electrical power that, in turn, may be distributed around the trailer for use with equipment auxiliary systems. In other embodiments, the trailer battery systems may work in conjunction with other power generation devices as well as the TEG sub-assemblies. These power generation assemblies may include but are not limited to solar power generation or from engine alternator systems. As well as supplying power to auxiliary systems, such as the turbine starters, lights or pumps, the power generated also may power the fracturing trailer control system. The power of this system would not only allow for related instrumentation to be powered from the TEG and battery assembly, but it also may allow for the monitoring of the voltage levels in the system, alert the equipment operator of potential reduced power generation, or alert the equipment operator that too much power consumption is occurring, thereby resulting in the batteries energy being used faster than it is being replenished.

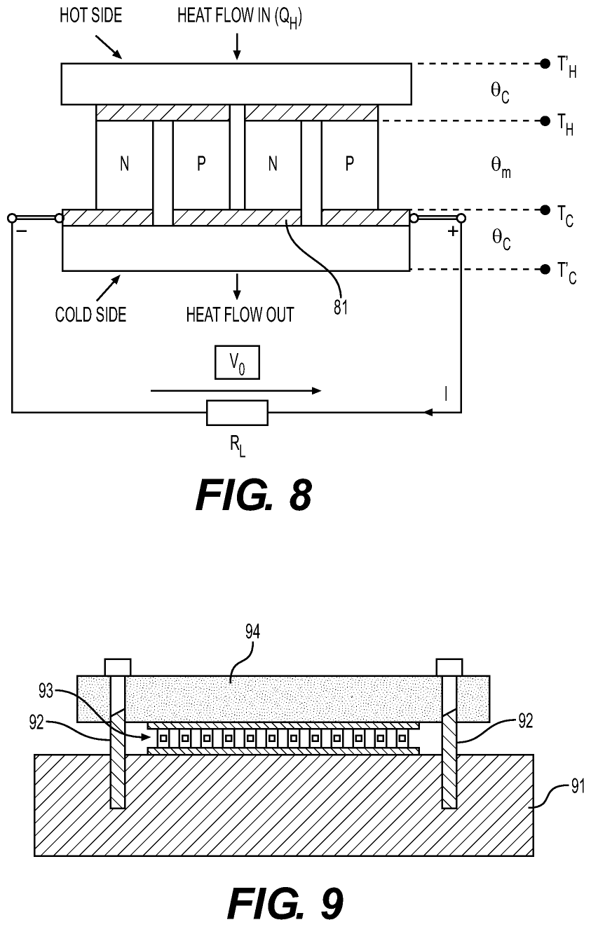

A power diagram of the TEG is shown in FIG. 8. TEG, for example, may be solid state semi-conductor devices that convert a temperature differential and heat flow into a useful DC power source. Thermoelectric generator semi-conductor devices utilize the setback effort to generate voltage. The building block of a TEG is a thermocouple. A thermocouple is made up of one ‘P’ type semi-conductor and one ‘N’. The semi-conductors are connected by a metallic strip 81 that connects these two semi-conductors in series. These semi-conductors also are known as “Pellets” that may be seen in FIG. 3B as reference numeral 33. When thermal energy is detected on the ‘Hot’ side as shown in FIG. 8, the charge carried within the semi-conductors diffuses away from the Hot Side to the Cold Side of the sub-assembly resulting in the electrons and holes to build up on one end of the semi-conductor. This, in turn, results in voltage potential that is directly proportional to the temperature differential across the semi-conductor. In an embodiment, by using the TEG on the surface of the exhaust stack, this allows recovery of a lot of the thermal energy lost from combustion resulting in clean power conversion.

In embodiments of a thermoelectric power generation system, the system further may include a solar energy recovery sub-assembly 530 positioned to collect and generate power responsive to solar exposure, and the set of TEG assemblies may be positioned to operate in conjunction with the solar energy recovery sub-assembly to enhance production and distribution of electrical power. The solar energy recovery sub-assembly 530 can be placed at any location where it is possible to capture energy from the sun and can have any configuration (e.g., tiltable) that can assist in capturing solar energy. Also, embodiments may include an onboard electrical supervisory control and data acquisition (SCADA) sub-assembly 540, and the set of TEG assemblies may be positioned to operationally supply power the onboard electrical SCADA sub-assembly to enhance monitoring and operations of other components and circuitry associated with the power generation assembly.

In addition, the set of batteries 520 of the system may be one or more sets of batteries. In embodiments, a fracturing pump auxiliary sub-assembly may be included that may have one or more lube pumps, one or more heat exchangers, one or more pump instruments, and additional sets batteries (or other power sources) and be positioned adjacent the hydraulic fracturing trailer assembly. Accordingly, in such embodiments, as will be understood by those skilled in the art, the set of TEG assemblies may operate to charge a second or additional sets of batteries, thereby to supply power to the fracturing pump auxiliary sub-assembly. Also, some embodiments may include a turbine engine auxiliary sub-assembly having one or more of a fuel sub-assembly, a gearbox sub-assembly, and an air supply sub-assembly, and the set of TEG assemblies may operate to charge the second or additional sets of batteries to supply power to the turbine engine auxiliary sub-assembly.

In a conventional fracturing set up, including a reciprocating diesel engine acting as the prime mover, the power generation is usually provided from an alternator that is directly mounted from a power take-off (PTO) on the engine. In an electrical fracturing set up, the power generation that is supplied from the main turbine genset is conditioned through transformers and switch gear to be able to be used for trailer auxiliaries. The use of an alternator installed on the direct drive turbine engine gearbox which, in turn, is then connected to a reciprocating plunger pump is not a feasible way to generate power. This is primarily a concern with dual shaft turbine engines that may see the Gas Generating Turbine (N1) turn with the Power Shaft (N2) remaining static which in the case of an alternator being installed on the gearbox would result in no power generation. In conjunction with the issue of the two engine shafts rotating separately, there is the case of the turbine engines output speed being variable which is an inevitable condition through the fracturing process. To combat these two complications, a diesel engine connected to a generator, or in other cases a hydraulic pump, is installed to support the power required by the auxiliary systems. These power assemblies are costly, require a lot of maintenance, and take up a lot of space onboard the factoring trailer. The installation of TEG assemblies on the direct drive turbine pump trailer would allow for the reduction in size of the auxiliary engine or, in some cases, the removal of the auxiliary engine from the trailer. The impact of these reductions and removals would not only allow for free space to be increased but also may allow for a reduction in weight allowing for the trailer to be comfortably compliant with state DOT weight and dimension trailer regulations, for example.

An embodiment of a method to generate thermoelectric power for a hydraulic fracturing trailer assembly having a high-power hydraulic fracturing generation assembly positioned thereon, for example, may include operating a high-power turbine engine of the power generation assembly when adjacent a fracturing well site so as to produce exhaust gas therefrom, supplying the exhaust gas from the high-power turbine engine into a turbine engine exhaust stack assembly, and generating thermoelectric power from a set of thermoelectric generation (TEG) assemblies responsive to heat from the exhaust gas in the turbine engine exhaust stack assembly so as to supply power to a power storage and distribution source associated with the hydraulic fracturing trailer assembly. The method also may include operating a diesel engine alternator when connected to the set of TEG assemblies to enhance production and distribution of electrical power across the high-power hydraulic fracturing generation assembly. In embodiments of the disclosure, the turbine engine exhaust stack assembly may include an exhaust stack housing and a TEG housing mount assembly, and the set of TEG assemblies may be mounted to the exhaust stack housing via the TEG housing mount assembly so that the TEG assemblies receive heat from the turbine engine exhaust stack assembly when mounted to the exhaust stack housing. The method further may include controlling power levels associated with components of the high-power hydraulic fracturing generation assembly via a controller and the set of TEG assemblies.

Using TEGs for thermal energy recovery can improve the reliability of the sub-assemblies. These devices, for example, may be solid state, have no moving parts to break or wear, and may operate effectively without failures or otherwise last a long time under sever operating conditions. The TEG assemblies also produce no noise pollution, unlike other methods for power generation, as well as generate no greenhouse gases. As demonstrated in FIG. 5, the use of TEGs may be scaled to the power demand required, and the entire surface of the exhaust stack may allow for TEG installation if the power demand calculated matches the sum of all TEGs and their individual power generation. If the TEGs were to be used for a specific piece of equipment on the fracturing trailer, however, then these may be scaled to support solely that device. By installing the TEG with simple bolting techniques, the compact size of the devices allows for installation on most surfaces without any specific material requirements. These applications may include but are not limited to power generation, operation of a pump, or the use of a turbine engine for propulsion.

This U.S. Non-Provisional patent application claims priority to and the benefit of, under 35 U.S.C. § 119(e), U.S. Provisional Application No. 62/705,358, filed Jun. 23, 2020, entitled “Energy Recovery for High Power Pumping Systems and Methods Using Exhaust Gas Heat to Generate Thermoelectric Power,” the disclosure of which is incorporated herein by reference in its entirety.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the present disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described. Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

What is claimed is:

1. A hydraulic fracturing power generation system positioned onboard a hydraulic fracturing trailer assembly, the system comprising:
a high power hydraulic fracturing generation assembly including:
(a) a turbine engine mounted to the hydraulic fracturing trailer assembly,
(b) a reduction gear box connected to the turbine engine and mounted to the hydraulic fracturing trailer assembly,
(c) a drive shaft connected to the reduction gear box and mounted to the hydraulic fracturing trailer assembly, and
(d) a turbine engine exhaust diffuser section mounted to the hydraulic fracturing trailer assembly and connected to the turbine engine;
a reciprocating plunger pump connected to the drive shaft and mounted to the hydraulic fracturing trailer assembly; and
a thermoelectric power generation assembly mounted to the hydraulic fracturing trailer assembly and including:
(a) a turbine engine exhaust stack assembly mounted to the hydraulic fracturing trailer assembly and connected to the turbine engine exhaust diffuser section,
(b) a set of thermo-electric generator (TEG) sub-assemblies connected to the turbine engine exhaust stack assembly to generate electric power responsive to the turbine engine exhaust stack assembly, and
(c) a power storage and distribution source mounted to the hydraulic fracturing trailer assembly to store and distribute power generated from the set of TEG sub-assemblies across the hydraulic fracturing trailer assembly.

2. The power generation system as defined in claim 1, wherein the power storage and distribution source comprises a set of batteries, and the system further comprising a diesel engine alternator mounted to the hydraulic fracturing trailer assembly and connected to the set of TEG sub-assemblies to enhance production and distribution of electrical power across the hydraulic fracturing trailer assembly.

3. The power generation system as defined in claim 2, further comprising a turbine engine starter motor mounted to the hydraulic fracturing trailer assembly, and wherein the set of TEG assemblies operatively charges the set of batteries to power the turbine engine starter motor for starting the turbine engine.

4. The power generation system as defined in claim 1, further comprising a solar energy recovery sub-assembly mounted to the hydraulic fracturing trailer assembly and positioned to collect and generate power responsive to solar exposure, and wherein the set of TEG sub-assemblies operates in conjunction with the solar energy recovery sub-assembly to enhance production and distribution of electrical power.

5. The power generation system as defined in claim 1, further comprising an onboard electrical SCADA sub-assembly mounted to the hydraulic fracturing trailer assembly, and wherein the set of TEG sub-assemblies operates to power the onboard electrical SCADA sub-assembly to enhance monitoring and operations of components and circuitry onboard the hydraulic fracturing trailer.

6. The power generation system as defined in claim 5, further comprising an electrical controller mounted to the hydraulic fracturing trailer assembly and in electrical communication with the TEG sub-assemblies to control and monitor power levels of the TEG sub-assemblies.

7. The power generation system as defined in claim 1, wherein the turbine engine exhaust stack assembly includes an exhaust stack housing and a TEG housing mount sub-assembly, and wherein the set of TEG sub-assemblies is mounted to the exhaust stack housing via the TEG housing mount sub-assembly.

8. The power generation system as defined in claim 2, wherein the set of batteries comprises a first set of batteries, and the power generation system further comprising power lighting equipment including a second set of batteries and being positioned adjacent the hydraulic fracturing trailer assembly, and wherein the set of TEG assemblies operates to charge the second set of batteries thereby to supply power to the power lighting equipment.

9. The power generation system as defined in claim 2, wherein the set of batteries comprises a first set of batteries, the system further comprising a fracturing pump auxiliary sub-assembly including one or more lube pumps, one or more heat exchangers, one or more pump instruments, and a second set of batteries and being positioned adjacent the hydraulic fracturing trailer assembly, and wherein the set of TEG assemblies operates to charge the second set of batteries thereby to supply power to the fracturing pump auxiliary sub-assembly.

10. The power generation system as defined in claim 1, wherein the set of batteries comprises a first set of batteries, the system further comprising a turbine engine auxiliary sub-assembly including one or more of a fuel assembly, a gearbox assembly, and an air supply sub-assembly, and wherein the set of TEG assemblies operates to charge the second set of batteries to supply power to the turbine engine auxiliary sub-assembly.

11. A thermoelectric power generation system mounted to a high-power hydraulic fracturing generation assembly, the high-power hydraulic fracturing generation assembly including a hydraulic fracturing trailer assembly, a turbine engine mounted to the hydraulic fracturing trailer assembly, a reduction gear box connected to the turbine engine and mounted to the hydraulic fracturing assembly, a drive shaft connected to the reduction gear box and mounted to the hydraulic fracturing assembly, and a turbine engine exhaust diffuser section connected to the turbine engine and mounted to the hydraulic fracturing assembly, the thermoelectric power generation system comprising:
a turbine engine exhaust stack assembly mounted to the hydraulic fracturing trailer assembly and connected to the turbine engine exhaust diffuser section;
a set of thermo-electric generator (TEG) assemblies connected to the turbine engine exhaust stack assembly to generate electric power responsive to the turbine engine exhaust stack assembly; and
a power storage and distribution source mounted to the hydraulic fracturing trailer assembly to store and distribute power generated from the set of TEG assemblies across the hydraulic fracturing trailer assembly.

12. The thermoelectric power generation system as defined in claim 11, wherein the power storage and distribution source comprises a set of batteries, and the system further comprising a diesel engine alternator connected to the set of TEG assemblies to enhance production and distribution of electrical power across the high power hydraulic fracturing generation assembly.

13. The thermoelectric power generation system as defined in claim 11, further comprising a solar energy recovery sub-assembly positioned to collect and generate power responsive to solar exposure, and wherein the set of TEG assemblies operates in conjunction with the solar energy recovery sub-assembly to enhance production and distribution of electrical power.

14. The thermoelectric power generation system as defined in claim 11, further comprising an onboard electrical SCADA sub-assembly, and wherein the set of TEG assemblies operates to power the onboard electrical SCADA sub-assembly to enhance monitoring and operations of components and circuitry associated with the power hydraulic fracturing generation assembly.

15. The thermoelectric power generation system as defined in claim 14, further comprising an electrical controller positioned in electrical communication with the set of TEG assemblies to control and monitor power levels of the TEG assemblies.

16. The thermoelectric power generation system as defined in claim 11, wherein the turbine engine exhaust stack assembly includes an exhaust stack housing and a TEG housing mount assembly, and wherein the set of TEG assemblies is mounted to the exhaust stack housing by the TEG housing mount assembly.

17. The thermoelectric power generation system as defined in claim 12, wherein the high-power hydraulic fracturing generation assembly further includes a turbine engine starter motor mounted to the hydraulic fracturing trailer assembly, and wherein the set of TEG assemblies charges the set of batteries to power the turbine engine starter motor for starting the turbine engine.

18. The thermoelectric power generation system as defined in claim 12, wherein the set of batteries comprises a first set of batteries, the system further comprising a fracturing pump auxiliary sub-assembly including one or more lube pumps, one or more heat exchangers, one or more pump instruments, and a second set of batteries and being positioned adjacent the hydraulic fracturing trailer assembly, and wherein the set of TEG assemblies operates to charge the second set of batteries thereby to supply power to the fracturing pump auxiliary sub-assembly.

19. The thermoelectric power generation system as defined in claim 11, wherein the set of batteries comprises a first set of batteries, the system further comprising a turbine engine auxiliary sub-assembly including one or more of a fuel sub-assembly, a gearbox sub-assembly, and an air sub-assembly, and wherein the set of TEG assemblies operates to charge the second set of batteries to supply power to the turbine engine auxiliary sub-assembly.

20. A hydraulic fracturing power generation system comprising:
a turbine engine;
a turbine engine exhaust diffuser section connected to the turbine engine; and
a thermoelectric power generation assembly including:
(a) a turbine engine exhaust stack assembly connected to the turbine engine exhaust diffuser section,
(b) a set of thermo-electric generator (TEG) sub-assemblies connected to the turbine engine exhaust stack assembly to generate electric power from exhaust gas expelled from the turbine engine, and
(c) a power storage and distribution source to store and distribute power generated from the set of TEG sub-assemblies.

21. A method to generate thermoelectric power for a hydraulic fracturing trailer assembly having a high-power hydraulic fracturing generation assembly positioned thereon, the high-power hydraulic fracturing generation assembly including a high-power turbine engine, the method comprising:
operating the high-power turbine engine of the high-power hydraulic fracturing generation assembly when adjacent a fracturing well site so as to produce exhaust gas therefrom;
supplying the exhaust gas from the high-power turbine engine into a turbine engine exhaust stack assembly; and
generating thermoelectric power from a set of thermoelectric generation (TEG) assemblies responsive to heat from the exhaust gas in the turbine engine exhaust stack assembly so as to supply power to a power storage and distribution source associated with the hydraulic fracturing trailer assembly.

22. The method as defined in claim 21, further comprising operating a diesel engine alternator when connected to the set of TEG assemblies to enhance production and distribution of electrical power across the high-power hydraulic fracturing generation assembly.

23. The method as defined in claim 22, wherein the turbine engine exhaust stack assembly includes an exhaust stack housing and a TEG housing mount assembly, and wherein the set of TEG assemblies is mounted to the exhaust stack housing via the TEG housing mount assembly.

24. The method as defined in claim 23, further comprising controlling power levels associated with components of the high-power hydraulic fracturing generation assembly via the set of TEG assemblies.

25. The method as defined in claim 21, further comprising operating a solar energy recovery sub-assembly positioned to collect and generate power responsive to solar exposure, and wherein the set of TEG assemblies operates in conjunction with the solar energy recovery sub-assembly to enhance production and distribution of electrical power.

26. The method as defined in claim 21, further comprising operating an onboard electrical SCADA sub-assembly, and wherein the set of TEG assemblies operates to power the onboard electrical SCADA sub-assembly to enhance monitoring and operations of components and circuitry associated with the high power hydraulic fracturing generation assembly.

27. The method as defined in claim 21, wherein the set of TEG assemblies is used to charge a set of batteries that are used to power a turbine engine starter motor for starting the turbine engine.
